(19) United States
(12) Patent Application Publication
(10) Pub. No.: US 2004/0185768 A1
(43) Pub. Date: Sep. 23, 2004

(54) Device for opening and closing passage and air conditioner for vehicle use

(76) Inventor: Masashi Mizutani, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/801,634

(22) Filed: Mar. 16, 2004

(30) Foreign Application Priority Data
Mar. 18, 2003 (JP) 2003-074101

(51) Int. Cl. B60H 1/00

(52) U.S. Cl. 454/160; 454/69

(57) ABSTRACT

When the packing member (43) made of elastic material is extended to an outer circumference of the door shaft (41) or provided on the bearing hole (52) side, clearance formed between the door shaft (41) and the bearing hole (52) is decreased. Due to the foregoing, as the packing member (43) is an elastic body, even if the packing member (43) comes into contact with the door shaft (41) or the bearing hole (52), the door (40) can be rotated. Accordingly, clearance between the door shaft (41) and the bearing hole (52) can be set at a sufficiently low value, and the leakage of an air from the clearance can be decreased.

### BACKGROUND OF THE INVENTION

1. Field of the Invention

The present invention relates to a device for opening and closing a passage in which a fluid flows. For example, the device for opening and closing a passage of the present invention is preferably used for an air mixing door of an air conditioner for vehicle use.

2. Description of the Related Art

In an air conditioner for vehicle use, a cantilever door is conventionally used as the air mixing door to adjust the temperature of the blowing air by adjusting a mixing ratio of the volume of a hot air to the volume of a cold air. This cantilever door includes: a door shaft 41; a plate-shaped door portion 42; and a packing member 244 bonded to the door portion 42 as shown in FIG. 9. The door shaft 41 is pivotally held by the bearing hole 52 of the case 11, and the opening portions 50, 51, in which air flows, are opened and closed, so that a ratio of air passing in the first opening portion 50 to air passing in the second opening portion 51 can be adjusted and the temperature of a conditioned air can be controlled.

However, in this structure, it is necessary for the door shaft 41 to be clearance-fitted into the bearing hole 52. Therefore, a clearance is necessarily generated between the door shaft 41 and the bearing hole 52. As a result, as shown by arrow C in FIG. 8, air leaks out from this clearance. In general, the door shaft 41 and the case 11 are formed by means of resin molding, and it is difficult to maintain severe dimensional accuracy in the case of resin molding. Therefore, it is impossible to sufficiently reduce the clearance formed between the door shaft 41 and the bearing hole 52, which causes a large leakage of air. Being affected by the leakage of air, a relation between the degree of opening of the air mixing door 40 and the temperature of the conditioned air becomes non-linear as shown by the broken line in FIG. 5.

### SUMMARY OF THE INVENTION

The present invention has been accomplished in view of the above points. It is an object of the present invention to provide a device for opening and closing a passage, in which a door is rotated around a door shaft so as to open and close an opening portion of a case, characterized in that the leakage of an air from clearance formed between the door shaft and the bearing hole is reduced.

In order to accomplish the above object, according to a first aspect of the present invention, there is provided a device for opening and closing a passage comprising: a door (40) having a door shaft (41), which becomes the center of rotation, and also having a plate-shaped door portion (42) for opening and closing an opening portion (50, 51); and a case (11) having a bearing hole (52) for pivotally holding the door shaft (41) and also having the opening portion (50, 51), wherein the opening portion (50, 51) of the device for opening and closing a passage is a passage in which air flows, and an elastic packing member (43, 143, 243) for reducing clearance between the door shaft (41) and the bearing hole (52) is attached to at least one of the door shaft (41) and the bearing hole (52).

Due to the above device for opening and closing a passage, a packing member is composed of an elastic body. Therefore, even if the packing member comes into contact with the door shaft or the bearing hole, the door can be rotated around the door shaft. Therefore, the clearance between the door shaft and the bearing hole can be set to a sufficiently low value. Accordingly, it is possible to reduce the leakage of an air from the clearance.

As the clearance is reduced by arranging the packing member, even if the diameter of the door shaft is decreased as compared with the conventional door shaft, the leakage of a blast of air is not affected by the door shaft of the small diameter. Accordingly, it is possible to reduce the diameter of the door shaft. When the diameter of the door shaft is reduced, the material cost of the door shaft can be decreased. Therefore, an increase in the manufacturing cost, which is made by adding the packing member, can be canceled. Alternatively, the manufacturing cost can be reduced as compared with the conventional structure.

According to a second aspect of the present invention, the door shaft (41) is provided with a large diameter shaft portion (41a) and a small diameter shaft portion (41b), and the packing member (43, 143, 243) is attached to only the small diameter shaft portion (41b) in the large diameter shaft portion and the small diameter shaft portion.

According to a third aspect of the present invention, the packing member (43) is attached to the door (40), and one piece of the packing member covers one face of the door portion (42) and one portion of the door shaft (41) in the circumferential direction.

According to a fourth aspect of the present invention, there is provided an air conditioner for vehicle use including a device for opening and closing a passage of the first aspect, wherein a heat exchanger (12) for cooling air and a heat exchanger (13) for heating air are arranged in the case (11) of the device for opening and closing a passage, and the opening (50, 51) of the device for opening and closing a passage is a passage in which air circulates, and wherein the device for opening and closing a passage can be applied to an air conditioner for vehicle use.

According to a fifth aspect of the present invention, the door (40) of the device for opening and closing a passage is an air mixing door for adjusting a ratio of the volume of a cold air cooled by the heat exchanger (12) for cooling to the volume of a hot air heated by the heat exchanger (13) for heating.

Due to the above structure, the leakage of an air from the clearance between the door shaft and the bearing hole can be reduced. Therefore, a relation between the degree of the opening of the air mixing door and the temperature of the conditioned air can be made linear. Therefore, the temperature control characteristic of the conditioned air can be enhanced.

Incidentally, the reference numerals in parentheses, to denote the above means, are intended to show the relationship of the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

In the drawings:

FIG. 1 is a front sectional view showing an air conditioning unit portion of an air conditioner for vehicle use to which a device for opening and closing a passage of the first embodiment of the present invention is applied;

FIG. 2 is an enlarged sectional view showing portion A in FIG. 1;

FIG. 3 is a sectional plan view showing portion A in FIG. 1;

FIG. 4 is a sectional view taken on line B-B in FIG. 3;

FIG. 5 is a characteristic diagram showing a relation between the degree of an opening of a rear seat air mixing door and the temperature of a conditioned air blown to the rear seat;

FIG. 6 is a sectional view showing a primary portion of the second embodiment of the present invention;

FIG. 7 is a sectional view showing a primary portion of the third embodiment of the present invention;

FIG. 8 is a view similar to FIG. 2; and

FIG. 9 is a sectional view showing a conventional device.

### DESCRIPTION OF PREFERRED EMBODIMENTS

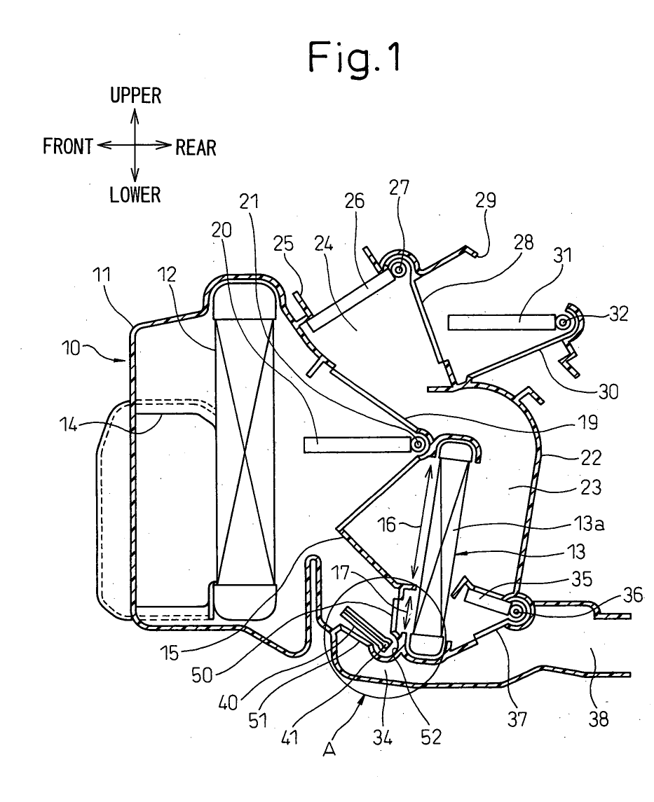

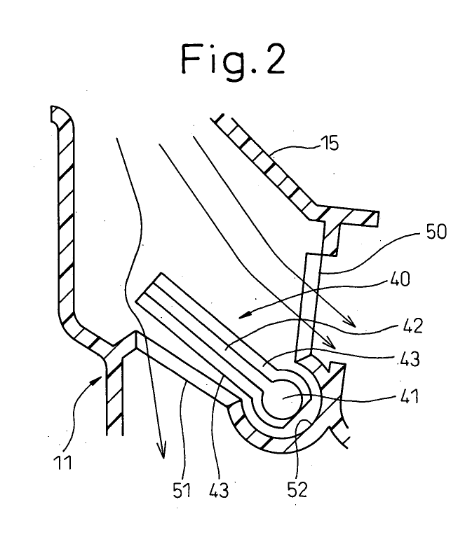

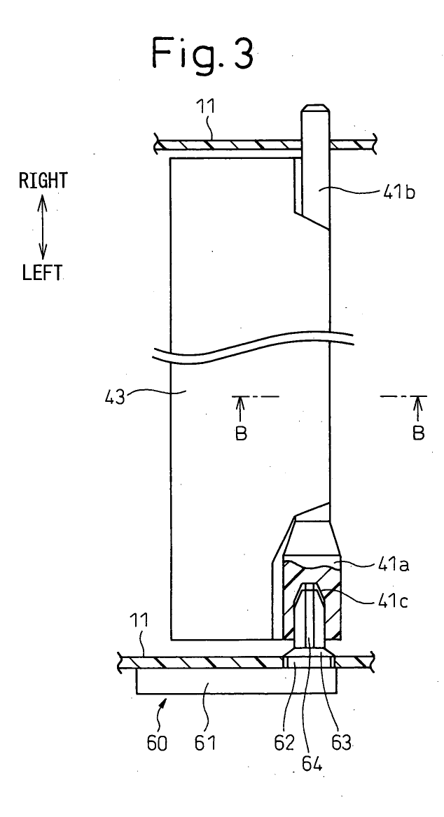

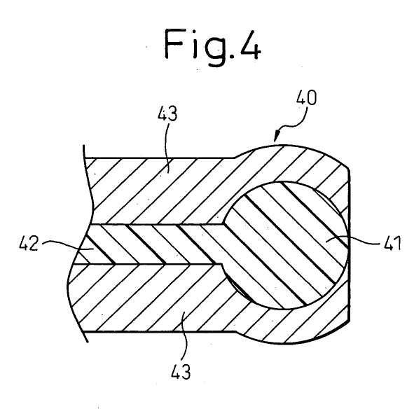

First of all, the first embodiment of the present invention will be explained below. FIGS. 1 to 4 are views showing the first embodiment. In this embodiment, the device for opening and closing a passage of the present invention is applied to an air conditioner for vehicle use. In this connection, FIG. 1 is a front sectional view showing an air conditioning unit portion of the air conditioner for vehicle use, FIG. 2 is an enlarged sectional view showing portion A in FIG. 1, FIG. 3 is a sectional plan view showing portion A in FIG. 1, and FIG. 4 is a sectional view taken on line B-B in FIG. 3.

According to the air conditioner for vehicle use of this embodiment, the temperature of the air blowing to the front seat side and the temperature of air blowing to the rear seat side can be independently controlled. The ventilating system of this air conditioner for vehicle use is mainly classified into the air conditioning unit 10 and the blower unit (not shown) for sending an air to this air conditioning unit 10. The blower unit is arranged being offset from the central portion to the passenger seat side in a lower portion of the instrument panel in the vehicle compartment. On the other hand, the air conditioning unit 10 is arranged at the substantial center in the lateral direction of the vehicle in the lower portion of the instrument panel in the vehicle compartment.

As well known, the blower unit includes: an inside and outside air changeover box for changing over between the air outside the vehicle compartment and the air inside the vehicle compartment; and a blower for sucking air through this inside and outside air changeover box and sending the sucked air.

In FIG. 1, the air conditioning unit 10 is composed in such a manner that both the evaporator 12 and the heater core 13 are integrally built in the air conditioning case 11 made of resin. The air conditioning unit 10 is arranged at the substantial center in the lower portion of the instrument panel in the vehicle compartment in the directions shown by the arrows in FIG. 1 which represent the directions of the upper, lower, right and left of the air conditioning unit 10. In this connection, the evaporator 12 corresponds to the heat exchanger for cooling of the present invention, and the heater core 13 corresponds to the heat exchanger for heating, of the present invention.

On the side of the front portion of the air conditioning case 11, the air inlet 14 is formed. Into this air inlet 14, an air flows from the outlet of the case of the blower of the blower unit.

In a portion in the air conditioning case 11 right after the air inlet 14, the evaporator 12 is arranged. This evaporator 12 is formed thin in the longitudinal direction of the vehicle and is arranged substantially vertically so that the evaporator 12 crosses a passage in the air conditioning case 11. Accordingly, a blast of air flows from the air inlet 14 onto the front face of the evaporator 12 extending in the vertical direction of the vehicle. As well known, this evaporator 12 absorbs latent heat of evaporation of the refrigerant in the refrigerating cycle and cools conditioned-air.

The heater core 13 is arranged on the downstream side of the evaporator 12 (rearward of the evaporator 12 in the vehicle) while a predetermined interval is being kept between the evaporator 12 and the heater core 13. This heater core 13 is arranged on the lower side in the air conditioning case 11 and is a little inclined to the rear side of the vehicle. In this connection, the width of the evaporator 12 and the heater core 13 in the lateral direction of the vehicle is designed to be substantially the same as the width of the air conditioning case 11.

The heater core 13 reheats a cold air which has passed through the evaporator 12. Hot water (engine coolant) of high temperature flows in the heater core 13. The heater core 13 heats air with the heat source of this hot water. As well known, the heater core 13 includes a core portion 13a for heat exchange composed of flat tubes, in which hot water flows, and corrugated fins joined to the flat tubes. An air passage of this core portion 13a for heat exchange is partitioned by the partitioning member 15 into the upper passage 16 for the front seat and the lower passage 17 for the rear seat. The partitioning member 15 is arranged on the upstream side of the air flow of the heater core 13 and extended in the width direction of the vehicle so that the partitioning member 15 can cover the inner space of the air conditioning case 11.

In the air passage in the air conditioning case 11, in an upper portion of the heater core 13, the cold air bypass passage 19 for the front seat, in which air (cold blast) flows bypassing the heater core 13, is formed.

A flat-plate-shaped air mixing door 20 for the front seat is arranged in a portion between the heater core 13 and the evaporator 12. This air mixing door 20 for the front seat adjusts a ratio of the volume of the hot air heated in the passage 16 for the front seat of the core portion 13a for heat exchange of the heater core 13 to the volume of the cold air bypassing the heater core 13 passing in the bypass passage 19 for the cold air for the front seat.

The air mixing door 20 for the front seat is integrated with the rotary shaft 21, which is horizontally arranged in the lateral direction of the vehicle, into one body. Therefore, the air mixing door 20 for the front seat can be independently rotated around the rotary shaft 21 in the upward and downward direction of the vehicle. The rotary shaft 21 is pivotally supported by the air conditioning case 11, and one end portion of this rotary shaft 21 is protruded outside the air conditioning case 11 and connected to an actuator mechanism, in which a servo motor is used, via a link mechanism not shown in the drawing. By this actuator mechanism, the rotary position of the air mixing door 20 is adjusted.

In the air conditioning case 11, in a portion on the downstream side of the air flow of the heater core 13 (on the rear side of the vehicle), the wall face 22, which extends in the vertical direction forming a predetermined interval between the heater core 13 and the wall face 22, is formed being integrated with the air conditioning case 11. The hot air passage 23 for the front seat, which is directed upward from a portion right after the heater core 13, is formed by this wall face 22.

On the downstream side (upper side) of the hot air passage 23 for the front seat, the air mixing portion 24 for the front seat is formed which joins onto the downstream side of the cold air bypass passage 19 in an upper portion of the heater core 13 so as to mix the cold air with the hot air.

On the upper face of the air conditioning case 11, the defroster opening portion 25 is open to a portion adjacent to the air mixing portion 24 for the front seat. Conditioned-air, the temperature of which has been controlled, flows into this defroster opening portion 25 from the air mixing portion 24. The defroster opening portion 25 is connected to a defroster outlet via a defroster duct not shown in the drawing. A conditioned air blows out from this defroster outlet toward the inner face of the windshield.

The defroster opening portion 25 is opened and closed by the flat-plate-shaped defroster door 26. This defroster door 26 is rotated around the rotary shaft 27 horizontally arranged in the neighborhood of the upper face of the air conditioning case 11.

This defroster door 26 changes over between the defroster opening portion 25 and the communicating port 28 so that the defroster opening portion 25 and the communicating port 28 can be opened and closed. This communicating port 28 is a passage in which a conditioned air sent from the air mixing portion 24 flows to the face opening portion 29 for the front seat and the foot opening portion 30 for the front seat.

On the upper face of the air conditioning case 11, the face opening portion 29 is provided in a portion on the rear side of the vehicle with respect to the defroster opening portion 25. This face opening portion 29 is connected to the face outlet, which is arranged on the upper side of the instrument panel, via the face duct not shown in the drawing. A conditioned air blows out from this face outlet toward the head portion of a passenger in the vehicle compartment.

In the air conditioning case 11, the foot opening portion 30 is provided on the lower side of the face opening portion 29. A conditioned-air, which has passed through the foot opening portion 30, blows out to the feet of a passenger via the foot duct not shown in the drawing.

A flat-plate-shaped foot and face changeover door 31 is arranged between the face opening portion 29 and the foot opening portion 30 and capable of being rotated around the rotary shaft 32. The face opening portion 29 and the foot opening portion 30 are changed over being opened and closed by this changeover door 31.

The defroster door 26 and the foot and face changeover door 31 are connected to a commonly used actuator mechanism, which is composed of a servo motor, via a link mechanism not shown in the drawing, and operated by the actuator mechanism by being interlocked with each other.

In the lower side portion of the heater core 13 in the air conditioning case 11, the cold air bypass passage 34 for the rear seat is formed, by which a cold air sent from the evaporator 12 can bypass the heater core 13.

On the downstream side portion of the air flow of the heater core 13, the hot air shutoff door 35 for the rear seat is pivotally arranged around the rotary shaft 36 being opposed to the passage 17 for the rear seat. This hot air shutoff door 35 is usually operated to be at the position shown in FIG. 1. Therefore, the communication between the passage 17 for the rear seat and the hot air passage 23 for the front seat of the heater core 13 is shut off by the hot air shutoff door 35, so that the passage 17 for the rear seat is communicated with the hot air passage 37 for the rear seat.

On the other hand, in a specific operating condition of the air conditioner, the hot air shutoff door 35 for the rear seat shuts off the communication between the passage 17 for the rear seat and the hot air passage 37 for the rear seat, so that the passage 17 for the rear seat can be communicated with the hot air passage 23 for the front seat. The hot air passage 37 for the rear seat is a passage for communicating the downstream side of the passage 17 for the rear seat of the heater core 13 with the air mixing portion 38 for the rear seat.

In this connection, the rotary shaft 36 of the hot air shutoff door 35 for the rear seat is connected to an actuator mechanism composed of a servo motor via a link mechanism not shown, and the hot air shutoff door 35 for the rear seat is operated by this actuator mechanism.

On the upstream side of the heater core 13, in a portion on the side of the passage 17 for the rear seat, a flat-plate-shaped air mixing door 40 for the rear seat is pivotally arranged around the rotary shaft 41.

In the neighborhood of the air mixing door 40 for the rear seat in the air conditioning case 11, the first opening portion 50 is formed which communicates the downstream side of the air flow of the evaporator 12 with the passage 17 for the rear seat of the heater core 13. Further, in the neighborhood of the air mixing door 40 for the rear seat in the air conditioning case 11, the second opening portion 51 is formed which communicates the downstream side of the air flow of the evaporator 12 with the cold air bypass passage 34 for the rear seat.

The air mixing door 40 for the rear seat is operated as follows. When the air mixing door 40 for the rear seat adjusts the degree of the opening of the first opening portion 50 and also adjusts the degree of the opening of the second opening portion 51, a ratio of the volume of the hot air passing in the passage 17 for the rear seat of the heater core 13 to the volume of the cold air passing in the cold air bypass passage 34 for the rear seat is adjusted, so that the temperature of the conditioned-air blowing onto the rear seat side in the vehicle compartment can be adjusted. A hot air sent from the hot air passage 37 for the rear seat and a cold air sent from the cold air bypass passage 34 for the rear seat are mixed in the air mixing portion 38 for the rear seat, and the temperature of the thus mixed air becomes a predetermined value.

Next, referring to FIGS. 2 to 4, the structure of the air mixing door 40 for the rear seat and the structure of the neighborhood of the air mixing door 40 will be described in detail as follows.

The air mixing door 40 for the rear seat includes: a rotary shaft 41 pivotally held by the bearing hole 52 formed on the air conditioning case 11; a flat-plate-shaped door portion 42 for opening and closing the first opening portion 50 and the second opening portion 51; and two pieces of elastic packing 43 covering the rotary shaft 41 and the door portion 42.

The rotary shaft 41 is formed into a stepped-shape having a large diameter shaft 41a and a small diameter shaft 41b. A cross-shaped engaging hole 41c is formed at the end portion of the rotary shaft 41 on the large diameter shaft 41a side. This rotary shaft 41 is horizontally arranged in the lateral direction of the vehicle. In this connection, the rotary shaft 41 corresponds to the door shaft of the present invention.

The air mixing door 40 for the rear seat is connected to an actuator mechanism not shown, in which a servo motor is used, via the link mechanism 60. A rotary position of the air mixing door 40 for the rear seat is adjusted by this actuator mechanism.

The link mechanism 60 is provided with the plate portion 61 and the shaft portion 62. In the shaft portion 62, the pawl portion 63 and the cross-shaped engaging piece 64 are formed. The shaft portion 62 is inserted into a through-hole formed on the air conditioning case 11 and prevented from coming out by the pawl portion 63. When the engaging piece 64 is inserted into the engaging hole 41c, the air mixing door 40 for the rear seat and the link mechanism 60 are rotated by being integrated with each other into one body.

The rotary shaft 41 and the door portion 42 are made of resin such as polypropylene by means of integral molding. The packing 43 is made of material characterized in that: when the material is given an external force, the shape is easily deformed; and when the external force is released, it returns to the initial shape. Concerning the specific material of the packing 43, a porous foamed material can be used. To be more specific, foamed urethane can be used.

Two packing members 43 are bonded to the rotary shaft 41 and the door portion 42. One packing member 43 covers all regions on one face of the door portion 42 and also covers a portion of the outer circumference of the small diameter shaft portion 41b of the door shaft 41. In more detail, one packing member 43 covers one portion of the small diameter shaft portion 41b in the axial direction as shown in FIG. 3. Further, as shown in FIG. 4, one packing member 43 covers one portion of the small diameter shaft portion 41b in the circumferential direction. In the same manner, the other packing member covers all regions on the other face of the door portion 42. Further, the other packing member covers one portion of the small diameter shaft portion 41b in the axial direction. Furthermore, the other packing member covers the residual portion of the small diameter shaft portion 41b in the circumferential direction.

A portion of the packing member 43 covering the outer circumference of the door shaft 41 is located between the door shaft 41 and the bearing hole 52, and the clearance formed between the door shaft 41 and the bearing hole 52 is reduced. Accordingly, the leakage of an air from the clearance can be decreased by the packing member 43.

In the air conditioner for vehicle use composed as described above, as well known, when the defroster door 26 and the foot and face changeover door 31 are controlled, the blowing mode on the front seat side is set. When a ratio of the volume of a cold air, which has passed in the cold air bypass passage 19, to the volume of a hot air, which has flowed into the passage 16 for the front seat of the heater core 13 and been heated, is adjusted by the air mixing door 20 for the front seat, the temperature of the conditioned-air blown out to the front seat side is controlled.

When a ratio of the volume of a hot air, which has passed in the passage 17 for the rear seat of the heater core 13, to the volume of a cold air, which has passed in the cold blast bypass passage 34 for the rear seat, is adjusted by the air mixing door 40 for the rear seat, the temperature of the conditioned-air blown out to the rear seat side is controlled. That is, when the positions of the openings of the air mixing door 20 for the front seat and the air mixing door 40 for the rear seat are independently controlled, the temperature of the air blown onto the front seat side and that of the air blown onto the rear seat side can be independently controlled.

In this case, the clearance formed between the door shaft 41 of the air mixing door 40 for the rear seat and the bearing hole 52 of the air conditioning case 11 is reduced by a portion of the packing 43 which covers the outer circumference of the door shaft 41. Therefore, a leakage of the air from the clearance can be decreased. As a result, it was confirmed, by experiments made by the inventors, that the relation between the degree of the opening of the air mixing door 40 for the rear seat and the temperature of the conditioned air blown onto the rear seat becomes linear.

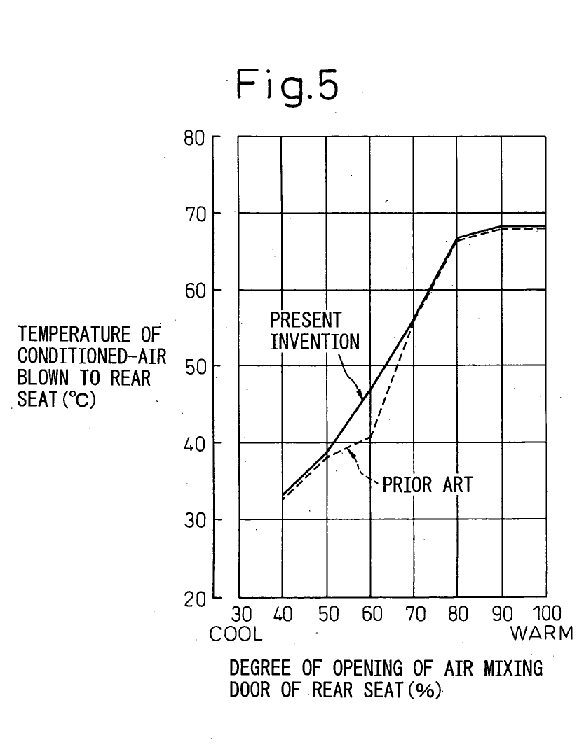

FIG. 5 is a graph showing the result of the experiment. In the conventional air conditioner, by the influence of a leakage of the air from the clearance between the door shaft 41 and the bearing hole 52, the temperature of the conditioned-air blown to the rear seat tends to become lower than the expected temperature in the neighborhood of 60% of the degree of the opening of the air mixing door 40 for the rear seat. On the other hand, in the air conditioner of this embodiment, the temperature of the conditioned-air blown to the rear seat becomes close to the expected temperature in the neighborhood of 60% of the degree of the opening of the air mixing door 40 for the rear seat. Therefore, it was confirmed that the relation between the degree of the opening of the air mixing door 40 for the rear seat and the temperature of the conditioned-air blown onto the rear seat substantially becomes linear in a range from the degree of the opening of 40% to the degree of the opening of 80% of the air mixing door 40 for the rear seat.

As described above, according to this embodiment, the portion of the packing member 43 covering the outer circumference of the door shaft 41 is located between the door shaft 41 and the bearing hole 52, and the clearance formed between the door shaft 41 and the bearing hole 52 is reduced. Accordingly, the leakage of an air from the clearance can be decreased by the packing member 43.

When the structure in which the outer circumference of the door shaft is covered with the packing is applied to the air mixing door 40, the relation between the opening of the air mixing door and the temperature of the conditioned-air becomes linear. Therefore, the temperature control characteristic of controlling the temperature of the conditioned-air can be enhanced.

As the packing member 43 is an elastic body, even if the packing member 43 comes into contact with the bearing hole 52, the door 40 can be rotated. Accordingly, the clearance between the door shaft 41 and the bearing hole 52 can be reduced to be a sufficiently low value. Therefore, the leakage of an air from the clearance can be decreased.

As the clearance is reduced by the packing member 43, even if the diameter of the door shaft 41 is decreased to smaller than the diameter of the door shaft of the conventional device, no leakage of an air is affected. Accordingly, the diameter of the door shaft 41 can be reduced. When the diameter of the door shaft 41 can be reduced, the material expense of the door shaft can be decreased. Therefore, it is possible to cancel an increase in the manufacturing cost caused when the packing member 43 is added. Alternatively, the manufacturing cost can be decreased as compared with the manufacturing cost of the conventional device.

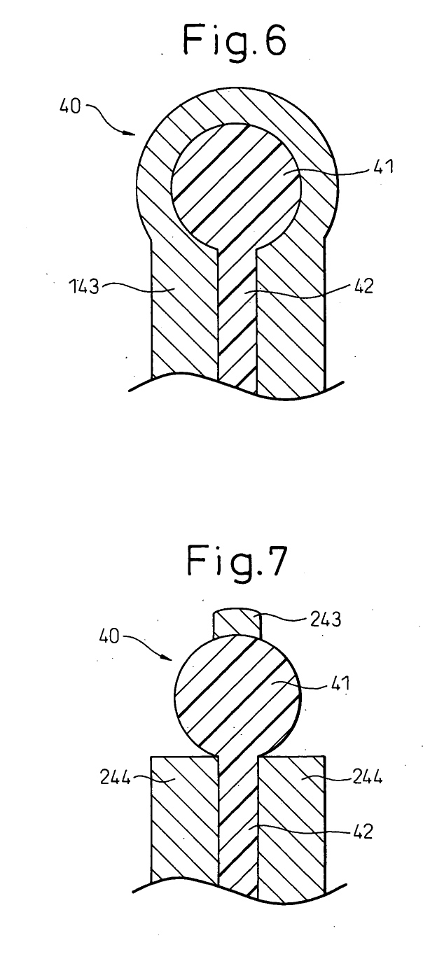

Next, the second embodiment will be explained below. FIG. 6 is a view showing the second embodiment. The second embodiment is different from the first embodiment in the structure of the packing member. Other points of the second embodiment are the same as those of the first embodiment.

In this embodiment, one piece of the packing member 143 is bonded to the air mixing door 40. That is, this one piece of the packing member 143 covers one portion of the small diameter shaft portion 41b of the door shaft 41 all over the regions in the circumferential direction of the small diameter shaft portion 41b. Further, this one piece of the packing member 143 covers all regions on both sides of the door portion 42.

The clearance between the door shaft 41 and the bearing hole 52 is reduced by a portion of the packing member 143 covering the outer circumference of the door shaft 41. Therefore, the second embodiment can provide the same effect as that of the first embodiment.

Next, the third embodiment will be explained below. FIG. 7 is a view showing the third embodiment. The third embodiment is different from the first embodiment in the structure of the packing member. Other points of the third embodiment are the same as those of the first embodiment.

In this embodiment, the following packing members are used so that they can be bonded to the air mixing door 40. One is the slender shaft portion packing member 243 bonded to the outer circumferential portion of the small diameter shaft portion 41b, and the other is the two pieces of the door packing members 244 respectively covering one face and the other face of the door portion 42. The shaft portion packing 243 covers one portion of the small diameter shaft portion 41b in the axial direction. Further, the shaft portion packing 243 covers one portion of the small diameter shaft portion 41b in the circumferential direction.

As the clearance between the door shaft 41 and the bearing hole 52 is reduced by the shaft portion packing member 243, this embodiment can provide the same effect as that of the first embodiment.

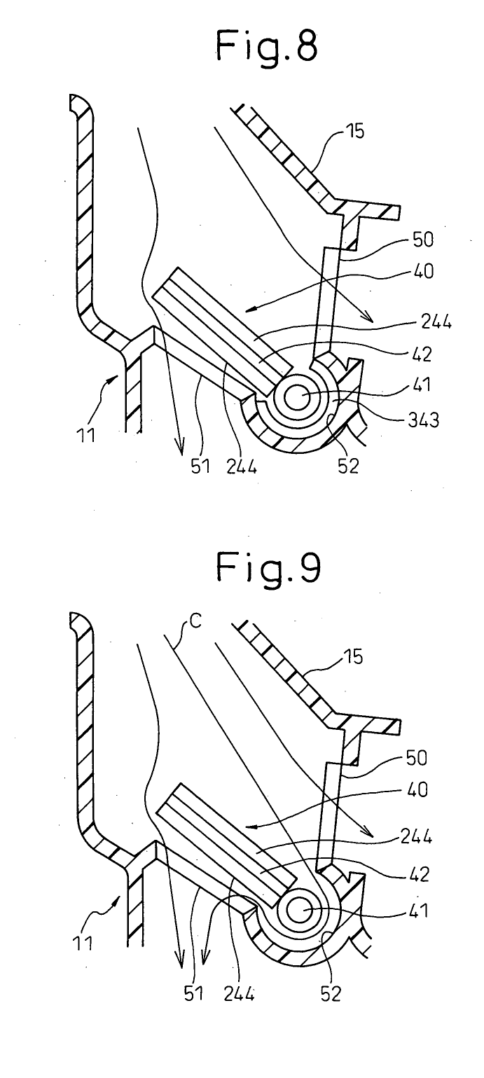

In this connection, even when the shaft packing 243 is abolished as shown in FIG. 8 which is similar to FIG. 2 and the packing member 343, the profile and size of which are the same as those of the shaft packing member 243, is attached to a portion on the inner circumferential face of the bearing hole 52 opposed to the small diameter shaft portion 41b, the same effect can be provided.

Finally, another embodiment will be explained below. In each embodiment described above, the present invention is applied to the air mixing door 40 for the rear seat. However, it should be noted that the present invention can be applied to the air mixing door 20 for the front seat. Further, the present invention can be applied to a so-called mode door such as a defroster door 26 and foot-face changeover door 31. Furthermore, the present invention can be applied to an inside and outside air door for changing over between the outside air and the inside air of a vehicle compartment.

In each embodiment described above, the present invention is applied to the door having the rotary shaft 41, the profile of which is formed into a stepped shape in which the large diameter shaft portion 41a and the small diameter shaft portion 41b are provided. However, it should be noted that the present invention can be applied to a door having a rotary shaft, the profile of which is not formed into the stepped shape.

Use of the present invention is not limited to the air conditioner for vehicle use. The present invention can be widely applied to the opening and closing device for opening and closing a fluid passage.

While the invention has been described by reference to specific embodiments chosen for purposes of illustration, it should be apparent that numerous modifications could be made thereto, by those skilled in the art, without departing from the basic concept and scope of the invention.

1. A device for opening and closing a passage comprising: a door (40) having a door shaft (41), which becomes the center of rotation, and also having a plate-shaped door portion (42) for opening and closing an opening portion (50, 51); and a case (11) having a bearing hole (52) for pivotally holding the door shaft (41) and also having the opening portion (50, 51), wherein
the opening portion (50, 51) of the device for opening and closing a passage is a passage in which air flows, and an elastic packing member (43, 143, 243) for reducing clearance between the door shaft (41) and the bearing hole (52) is attached to at least one of the door shaft (41) and the bearing hole (52).

2. A device for opening and closing a passage according to claim 1, wherein the door shaft (41) is provided with a large diameter shaft portion (41a) and a small diameter shaft portion (41b), and the packing member (43, 143, 243) is attached to only the small diameter shaft portion (41b) in the large diameter shaft portion and the small diameter shaft portion.

3. A device for opening and closing a passage according to claim 1, wherein the packing member (43) is attached to the door (40), and one piece of the packing member covers one face of the door portion (42) and one portion of the door shaft (41) in the circumferential direction.

4. An air conditioner for vehicle use including a device for opening and closing a passage described in claim 1, wherein a heat exchanger (12) for cooling air and a heat exchanger (13) for heating air are arranged in the case (11) of the device for opening and closing a passage, and the opening (50, 51) of the device for opening and closing a passage is a passage in which air circulates.

5. An air conditioner for vehicle use according to claim 4, wherein the door (40) of the device for opening and closing a passage is an air mixing door for adjusting a ratio of the volume of a cold air cooled by the heat exchanger (12) for cooling to the volume of a hot air heated by the heat exchanger (13) for heating.
